(19) United States
(12) Patent Application Publication
(10) Pub. No.: US 2010/0245923 A1
(43) Pub. Date: Sep. 30, 2010

(54) IMAGE FORMING APPARAUS, IMAGE FORMING METHOD, AND COMPUTER READABLE MEDIUM

(75) Inventors: Michihisa NEZU, Ebina-shi (JP); Yasuhiro Nakatani, Ebina-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/566,986

(22) Filed: Sep. 25, 2009

(30) Foreign Application Priority Data
Mar. 24, 2009 (JP) 2009-072796

(51) Int. Cl. H04N 1/40

(52) U.S. Cl. 358/2.1

(57) ABSTRACT

An image forming apparatus includes: an acquisition unit that acquires image information that represents an image; a formation unit that forms the image that the image information that the acquisition unit acquires represents onto a medium; a trimming unit that trims the medium onto which the formation unit forms the image; and a determination unit that determines an edge cut from the image based on the size of a trimmed part of the medium trimmed by the trimming unit, the size of the medium, and the size of the image that the image information represents, wherein the formation unit forms the image of which the edge that the determination unit determines to cut is cut onto the medium so that the edge of the image is located at a position based on the trimmed part that the trimmed unit trims.

### CROSS-REFERENCE TO RELATED APPLICATION

This application is based on and claims priority under 35 USC 119 from Japanese Patent Application No. 2009-072796 filed Mar. 24, 2009.

### BACKGROUND

1. Technical Field

This invention relates to an image forming apparatus, an image forming method, and a computer readable medium.

2. Related Art

There has been conventionally known a printer device that prevents unsightly margins from being left on each page of a booklet when the printer trims the edge of the booklet it creates.

### SUMMARY

According to an aspect of the present invention, there is provided an image forming apparatus including: an acquisition unit that acquires image information that represents an image; a formation unit that forms the image that the image information that the acquisition unit acquires represents onto a medium; a trimming unit that trims the medium onto which the formation unit forms the image; and a determination unit that determines an edge cut from the image based on the size of a trimmed part of the medium trimmed by the trimming unit, the size of the medium, and the size of the image that the image information represents, wherein the formation unit forms the image of which the edge that the determination unit determines to cut is cut onto the medium so that the edge of the image is located at a position based on the trimmed part that the trimmed unit trims.

### BRIEF DESCRIPTION OF THE DRAWINGS

Exemplary embodiments of the present invention will be described in detail based on the following figures, wherein:

FIGS. 1A and 1B are configuration diagrams illustrating an example of an image forming system including an image forming apparatus in accordance with an exemplary embodiment of the present invention;

FIGS. 2A and 2B are diagrams explaining an example of the edge trimming that the image forming apparatus executes;

FIGS. 3A and 3B are hardware configuration diagrams illustrating an example of a configuration of the controller;

FIGS. 4A and 4B are diagrams illustrating an example of the image formed onto the medium;

FIG. 5 is a hardware configuration diagram illustrating an example of a configuration of the decode unit; and

FIG. 6 is a diagram illustrating an example of the image forming process that the image forming apparatus executes.

### DETAILED DESCRIPTION

A description will now be given, with reference to the accompanying drawings, of exemplary embodiments of the present invention.

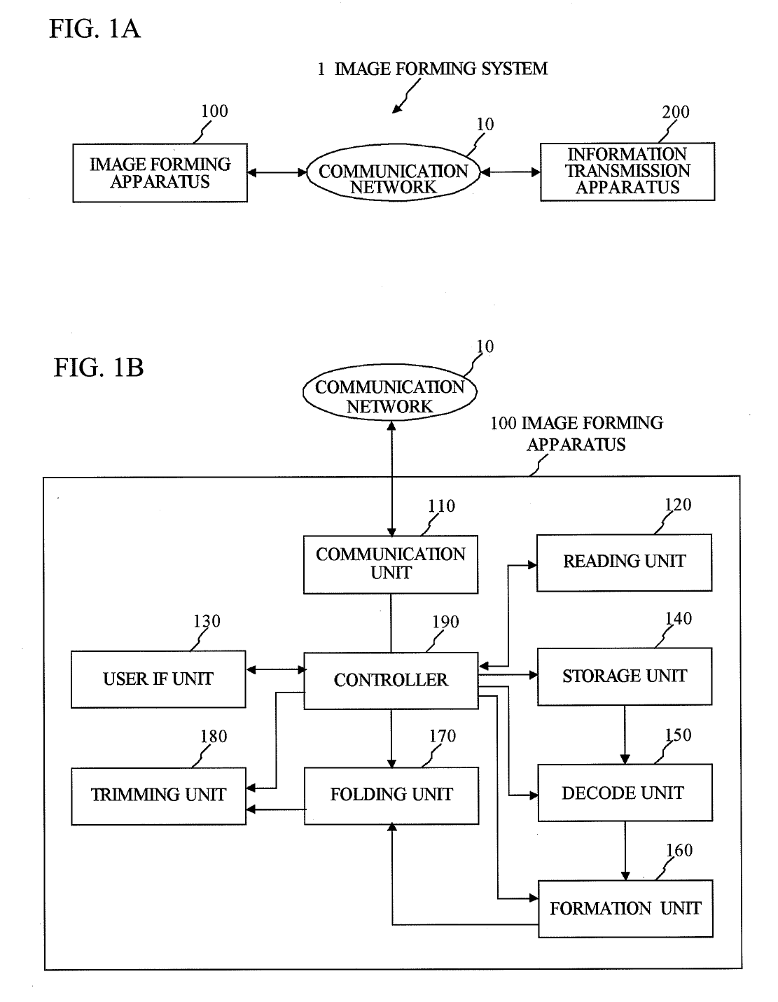

FIGS. 1A and 1B are configuration diagrams illustrating an example of an image forming system including an image forming apparatus in accordance with an exemplary embodiment of the present invention.

An image forming system 1 illustrated in FIG. 1A includes a communication network 10, an image forming apparatus 100, and an information transmission apparatus 200.

The communication network 10 is built with LAN (Local Area Network), WAN (Wide Area Network), MAN (Metropolitan Area Network), or a public line network for example.

The description about the information transmission apparatus 200 will be given anterior to the description about the image forming apparatus 100 is given. The information transmission apparatus 200 is configured with a personal computer for example. The information transmission apparatus 200 communicates a variety of information with the image forming apparatus 100. More specifically, the information transmission apparatus 200 transmits the image information that represents the image and the instruction that instructs the image forming apparatus 100 to form the image that the image information represents to the image forming apparatus 100.

The image information is the information of an image compressed with the compression technology such as JPG (Joint Photographic Experts Group). In this embodiment, the description will be given assuming that the compression technology, which is used in the image information, compresses the image by describing the line of pixels composing the image by referring to the line of pixels that the information, which lies anterior to the line of pixels composing the image, represents. More specifically, the image information compressed with this compression technology describes the information that Nth line of pixels (call the line of pixels just line hereinafter) in main scanning direction is same as Mth line at least after the information that represents the compressed Mth line (however N>M). Although the image information is described as the information compressed with JPG in this embodiment, it is not limited to this embodiment. The image information can be information compressed with PNG (Portable Network Graphics), GIF (Graphics Interchange Format), and JBIG (Joint Bi-level Image Experts Group) for example.

The image forming apparatus 100 is, for example, configured with a complex machine featuring functions such as a reading function that reads the image optically, an image forming function that forms the image, an information communication function that communicates information, and an FAX (facsimile) function that sends and receives FAX.

The description will be given about the configuration of the image forming apparatus 100 with reference to FIG. 1B. FIG. 1B is a functional block diagram illustrating an example of the configuration of the image forming apparatus 100.

The image forming apparatus 100 illustrated in FIG. 1B includes a communication unit 110, a reading unit 120, a user interface unit (a user IF unit) 130, a storage unit 140, a decode unit 150, a formation unit 160, a folding unit 170, a trimming unit 180, and a controller 190.

The communication unit 110 is configured with a network card for example. The communication unit 110 communicates a variety of information and instructions with the information transmission apparatus 200 to which the communication unit 110 is coupled via the communication network 10. The communication unit 110 inputs and outputs the communication information with the controller 190.

The reading unit 120 is configured with an IIT (Image Input Terminal) for example. The reading unit 120 reads the original document put onto the platen optically, and outputs the image information that the reading unit 120 has read to the controller 190, for example. The image information that the reading unit 120 outputs is compressed with the same compression technology as used to the image information that the information transmission apparatus 200 transmits.

The user IF unit 130 includes an input unit and a display. The input unit is configured with a touch panel or mechanical switches for example. The input unit is operated by the user of the image forming apparatus 100 (call the user of the image forming apparatus 100 just the user hereinafter), and inputs various commands to the controller 190. More specifically, the commands that the input unit inputs includes an image formation command, a folding command, an edge trimming command, and N-Up command. The image formation command is the command to form the image. The folding command is the command to fold the medium on which the image is formed in two. The medium on which the image is formed includes a printing medium formed by print of images for example. More specifically, the printing medium includes printing papers, fabrics, plastic cards, wooden boards, and iron boards, but is not limited to these. Folding does not mean necessarily folding at the center of the medium. The edge trimming command is the command to trim the edge of the medium on which the image is formed. The N-Up command is the command to form multiple images onto one side of a single medium.

The display is configured with a CRT (Cathode Ray Tube), a liquid crystal panel, or an organic EL (Electro-Luminescence). The display displays a variety of information based on the control of the controller 190.

The storage unit 140 is configured with a storage device such as a hard disk or a semiconductor memory. A variety of information is stored in the storage unit 140. More specifically, the image information that the communication unit 110 receives is stored in the storage unit 140 based on the control of the controller 190. The image information that the storage unit 140 stores is referred to by the controller 190.

The decode unit 150 decodes the image information that the storage unit 140 stores. Then, the decode unit 150 outputs the information that represents the decoded image to the formation unit 160.

The formation unit 160 is configured with an IOT (Image Output Terminal) for example. The formation unit 160 forms the image that the information that the decode unit 150 decodes represents onto the medium. The decode unit 150 and the formation unit 160 will be described in detail after.

The folding unit 170 is configured with a finisher. The folding unit 170 folds the media on which the formation unit 160 forms the image. As a concrete example, the folding unit 170 folds the stacked media in two at about the center of the stacked media in the vertical scanning direction so as to form the folding line in the main scanning direction.

The trimming unit 180 is configured with a trimmer for example. The trimming unit 180 trims media on which the formation unit 160 forms the image. More specifically, the trimming unit 180 executes the edge trimming to the media that the folding unit 170 folds.

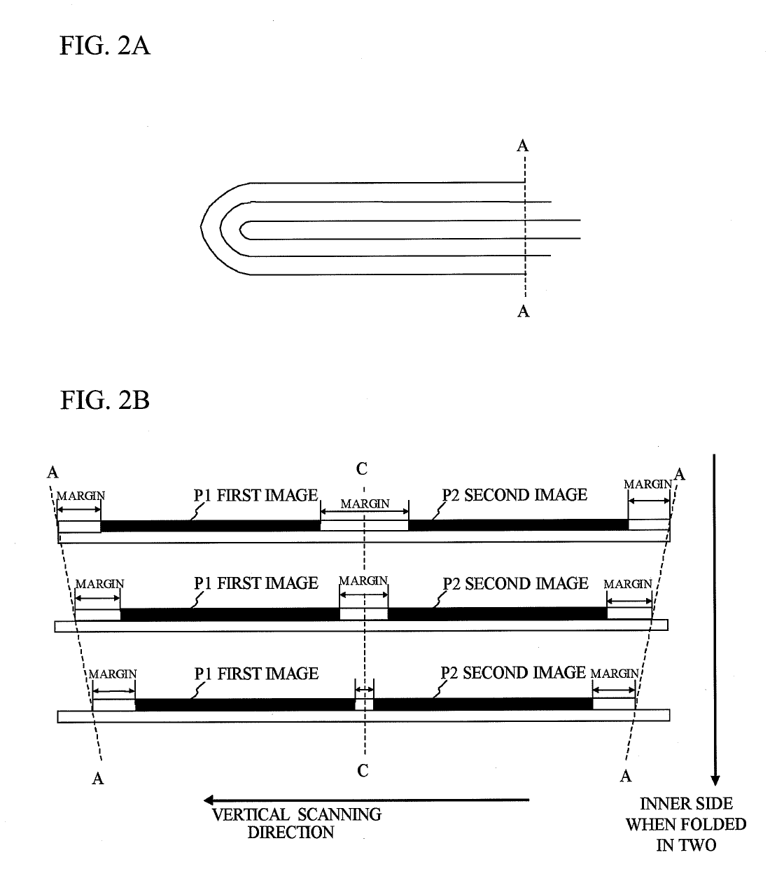

Now the description will be given of the edge trimming that the trimming unit 180 executes, with reference to FIGS. 2A and 2B. FIG. 2A is a diagram to explain an example of the edge trimming that the image forming apparatus 100 executes.

FIG. 2A illustrates a stack of printing media folded in two under the stacked condition and formed as a booklet. In this stack of the printing media, the edge of the outer medium under the folded condition lies closer to folding line formed by the folding than the edge of the inner medium. The edge trimming that the image forming apparatus 100 executes includes trimming other stacked printing media along the edge of this outer medium for example. In FIG. 2A, the dash line A indicates the position to trim the printing media.

The description will be given of the configuration of the image forming apparatus 100, with reference to FIG. 1.

The controller 190 is configured with the microcomputer for example. The controller 190 controls each unit to which the controller 190 is coupled by executing the software process.

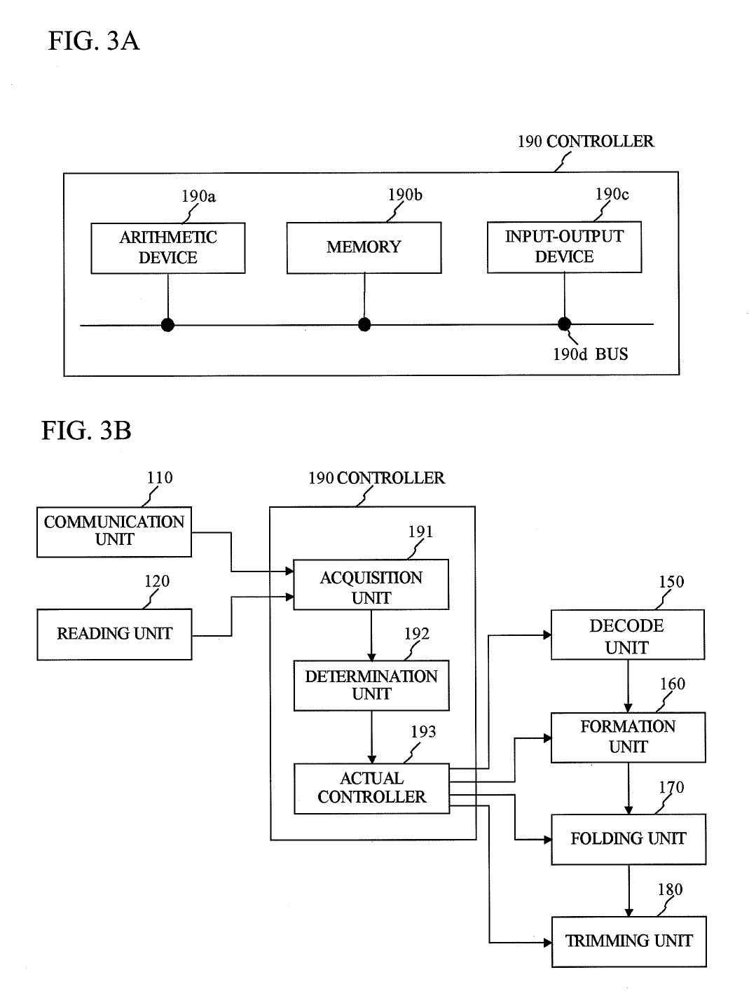

The hardware configuration that the controller 190 uses to execute the software process will be described with reference to FIGS. 3A and 3B. FIG. 3A is a hardware configuration diagram illustrating an example of the configuration of the controller 190.

The controller 190 illustrated in FIG. 3A includes an arithmetic device 190a such as CPU (Central Processing Unit), a memory 190b such as a ROM (Read-Only Memory) or RAM (Random Access Memory), and an input-output device 190c such as an AD (Analog-to-Digital) converter. The software process is implemented in that the arithmetic device 190a reads in the program stored in the memory 190b and executes the calculation according to the execution procedure of the software process that the read in program represents. The calculation result of the arithmetic device 190a is written to the memory 190b. As necessary, the input-output device 190c inputs signals inputted from each unit coupled to the controller 190 as the calculation object, and outputs the calculation result to each unit coupled to the controller 190.

The control that the controller 190 executes is outlined with reference to FIG. 2B. FIG. 2B is a diagram illustrating the stacked printing media viewed from the main scanning direction. The dash line A illustrated in FIG. 2B is the dash line A illustrated in FIG. 2A. The line C illustrated in FIG. 2B indicates the folding line along which the printing media are folded.

As illustrated in FIG. 2B, the controller 190 controls the formation unit 160 to form two images onto a single medium (to execute 2-Up). The controller 190 controls the formation unit 160 to form the images onto the medium so that the edges of the two images are located at the positions based on the trimmed part that the trimming unit 180 trims respectively. More specifically, the controller 190 controls the formation unit 160 to form the two images onto the medium with the predetermined margin from the trimmed part. Therefore, if the medium is located in the more inner side under the folded condition, the distance (margin) between the first image P1 formed on the upper side and the second image P2 formed on the lower side gets shorter in the vertical scanning direction.

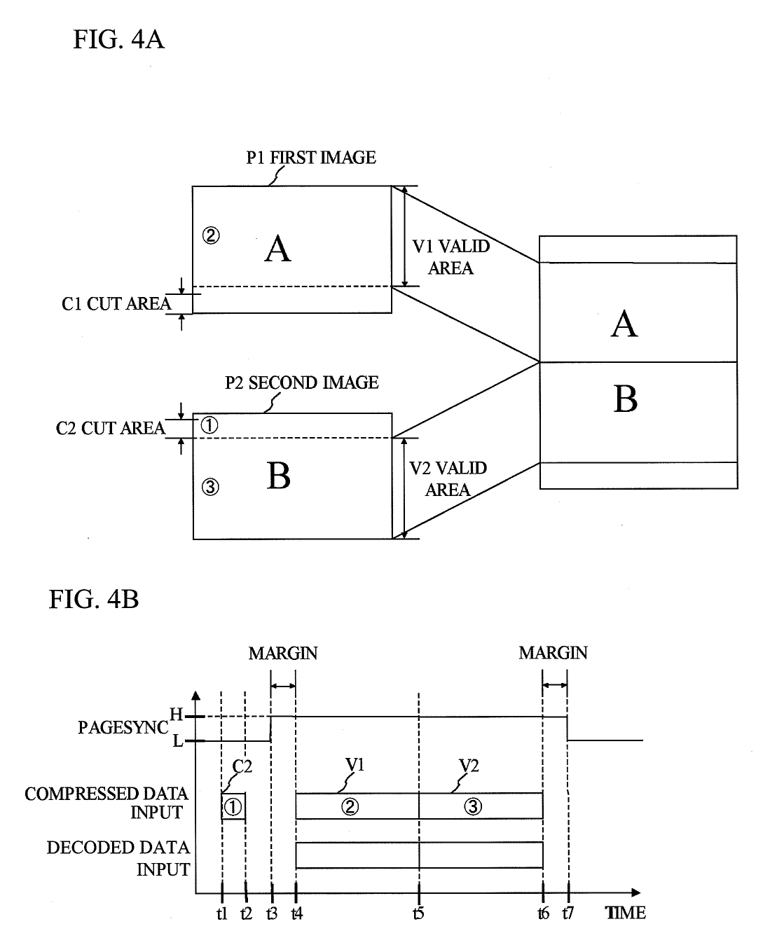

With reference to FIGS. 4A and 4B, the description will be given about the control that the controller 190 executes when the total value S of the lengths of the first image P1 and the second image P2 in the vertical scanning direction, and the lengths of predetermined two margins is equal to or more than the length of the trimmed media. FIG. 4A is a diagram illustrating an example of the image formed onto the medium.

As illustrated in FIG. 4A, the controller 190 controls the decode unit 150 to cut each of the lower edge of the first image and the upper edge of the second image based on the difference value between the total value S and the length of the medium when the total value S exceeds the length of the medium, and to decode the image information that represents the first image (the first image information) and the image information that represents the second image (the second image information). This is because the margins are often left at the upper edge and the lower edge of the image.

Particularly, the controller 190 controls the cut lengths of the edges of the first image and the second image so that the first image and the second image formed on the medium are not over the folding line along which the medium is folded by the folding unit 170. Then the controller 190 controls the formation unit 160 to form the first image and the second image, of that the edges are cut, at the positions based on the trimmed part of the medium respectively. In the first image P1 and the second image P2, the edges to be cut are called the cut parts (or cut areas) C1 and C2. Meanwhile, in the first image P1 and the second image P2, each of the parts not to be cut is called the valid parts (or valid areas) V1 and V2.

With reference to FIG. 3B, the configuration of the controller 190 is described from the functional point. FIG. 3B is a functional block diagram illustrating an example of the configuration of the controller 190.

The controller 190 illustrated in FIG. 3B includes an acquisition unit 191, a determination unit 192, and an actual controller 193.

The acquisition unit 191 is implemented in the acquisition process the arithmetic device 190a executes. The acquisition unit 191 acquires the image information that represents the image that the communication unit 110 receives, or the image information that the reading unit 120 reads.

The determination unit 192 is implemented in the determination process that the arithmetic device 190a executes. As described in FIGS. 4A and 4B, the determination unit 192 determines the edge to be cut from the image (the cut part). More specifically, the determination unit 192 determines the cut part based on the size of the medium after the trimming, the size of the image that the image information represents, and the size of the predetermined margin. The determination unit 192 determines the size of the medium after the trimming with the size of the trimmed part of the medium trimmed by the trimming unit 180 and the size of the medium.

The determination unit 192 determines the size of the trimmed part of the medium. More specifically, the determination unit 192 determines the trimmed part based on the number of pages of the booklet compiled with the media on which the images are formed, the thickness of the printing medium, and the folding line.

The actual controller 193 is implemented in the actual control process that the arithmetic device 190a executes. The actual controller 193 controls the decode unit 150 to cut the cut part that the determination unit 192 determines, and decode the first image information and the second image information.

With reference to FIG. 4B, the control to the decode unit 150 that the actual controller 193 executes is described. FIG. 4B is a diagram illustrating an example of the control to the decode unit 150 that the actual controller 193 executes.

In FIG. 4B, the vertical axis indicates the pagesync, the compressed data input, and the decoded data output, and the horizontal axis indicates time. The pagesync will be described after. The compressed data input indicates the compressed image information inputted to the decode unit 150 (hereinafter, call this the compressed information). The decoded data output indicates the decoded image information that the decode unit 150 outputs (hereinafter, call this the decoded information). The pagesync indicates the timing when the formation unit 160 forms the image that the information inputted from the decode unit 150 represents onto the medium that becomes one page of the booklet. More specifically, when the value of the pagesync is “High”, the formation unit 160 sequentially forms the image, that the inputted information represents, from the vertical scanning direction. When the value of the pagesync is “Low”, the formation unit 160 does not form the image that the inputted information represents.

As illustrated in FIG. 4B, the value of the pagesync is “Low” from the time t1 to the time t2. In this time interval, the actual controller 193 controls the decode unit 150 to input the compressed information that represents the cut part C2 of the second image P2. This is because the decode unit 150 uses the cut part C2 to decode the valid part V2 of the second image P2. This is also because image missing may occur because the value of the pagesync is “High”, if the decode unit 150 decodes the cut part C2 after decoding the valid part V1 of the first image P1.

Then, at the time t3, the value of the pagesync becomes “High”. The actual controller 193 controls the decode unit 150 not to input the information from the time t3 to the time t4. This is for preventing the formation of the image in the predetermined margin and the trimmed part that the determination unit 192 determines because of the information outputted from the decode unit 150 to the formation unit 160.

Then the actual controller 193 controls the decode unit 150 to input the first image information from the time t4 to the time t5. The actual controller 193 determines the time t5 based on the length in the vertical scanning direction of the valid part V1 of the first image P1 that the determination unit 192 determines. At the time t4, the formation unit 160 that acquires the decoded information from the decode unit 150 starts to form the valid part V1 of the first image P1 that the decoded image represents onto a medium.

In the same way, the actual controller 193 controls the decode unit 150 to input the second image information from the time t5 to the time t6. The decode unit 150 decodes the compressed information that represents the valid part V2 with the information that represents the cut part C2 decoded from the time t1 to the time t2.

Then, the actual controller 193 executes same control from the time t3 to the time t4, from the time t6 to time t7.

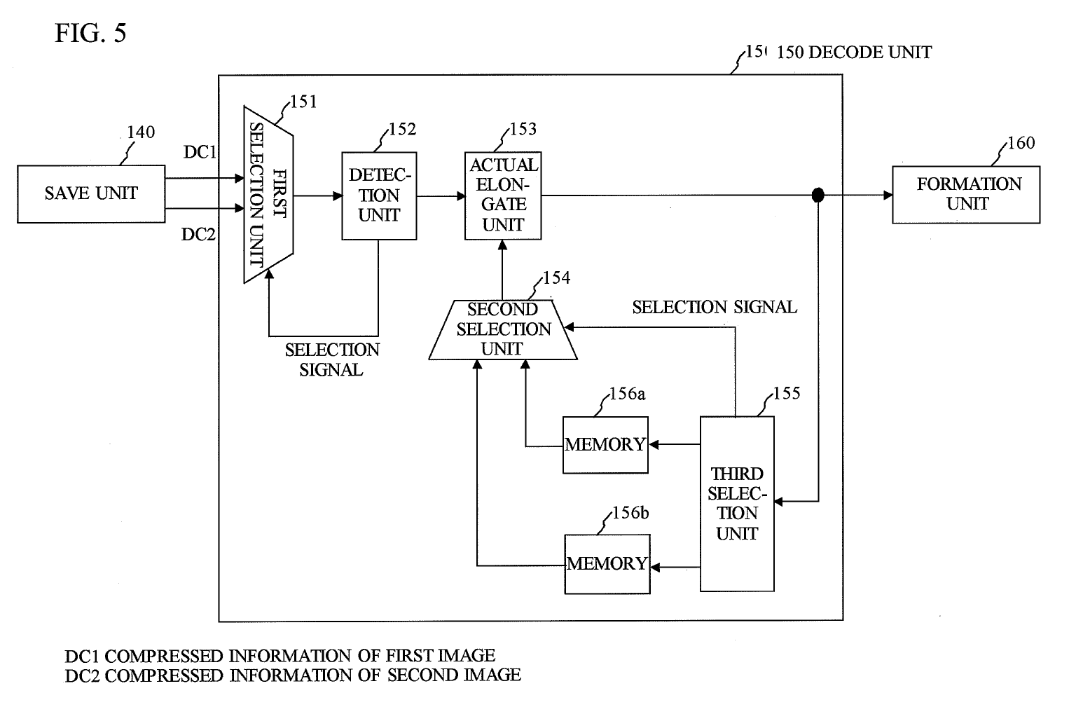

With reference to FIG. 5, the configuration of the decode unit 150 is described in detail. FIG. 5 is a hardware configuration diagram illustrating an example of the configuration of the decode unit 150.

The decode unit 150 illustrated in FIG. 5 includes a first selection unit 151, a detection unit 152, an actual decode unit 153, a second selection unit 154, a third selection unit 155 and memories 156a and 156b.

The first selection unit 151 through the third selection unit 155 are configured with hardware circuits for example. The first selection unit 151 is controlled by the controller 190, and selects the image information to be decoded from the compressed information of the first image and the compressed information of the second image stored in the storage unit 140. More specifically, the first selection unit 151 selects the image information according to the sequence that the formation unit 160 forms images after selecting the image information that represents the image with the information that the cut part that the determination unit 192 determines lies anterior to the valid part. As illustrated in FIG. 4A, the cut part C2 lies anterior to the valid part V2 in the second image information. Therefore, the first selection unit 151 selects the second image information. Then, because the formation unit 160 forms images sequentially from the top to the bottom in the vertical scanning direction, the first selection unit 151 selects the second image information that represents the second image located on the lower side after selecting the first image information that represents the first image located on the upper side in the vertical scanning direction.

The detection unit 152 detects the line end identification code that indicates the end of line from the compressed information that the first selection unit 151 selects. The detection unit 152 detects the number of decoded lines and detects the completion of each decode of the cut part C2, and the valid parts V1 and V2, based on the number of the code that the detection unit 152 detected. The detection unit 152 outputs the selection signal that instructs the first selection unit 151 to select the compressed information to be decoded next to the first selection unit 151 after detecting the completion of the decode.

The actual decode unit 153 decodes the compressed information with respect to the line with the information that the third selection unit 155 selects. The actual decode unit 153 outputs the information that the actual decode unit 153 decoded to the formation unit 160 and the third selection unit 155 sequentially.

The second selection unit 154 selects the information that the memories 156a and 156b store, and outputs the selected information to the actual decode unit 153. More specifically, the second selection unit 154 selects the information, that lies anterior to the compressed information to be decoded in the image information that the first selection unit 151 selected (hereinafter, call it the selected image information) and is decoded, among the selected image information. The second selection unit 154 selects the information decoded by the actual decode unit 153 among the selected image information; the information represents the line located on the upper side in the image that the selected image information represents in the vertical scanning direction than the line that the compressed information to be decoded represents.

The third selection unit 155 selects one of the memories 156a and 156b, and overwrites and saves the information that the actual decode unit 153 decodes to the selected memory with respect to each line. More specifically, the third selection unit 155 saves the information that is the decoded first image information to the memory 156a, and saves the information that is the decoded second image information to the memory 156b. The memories 156a and 156b are configured with semiconductor memories for example.

With reference to FIG. 3B, the configuration of the actual controller 193 will be described.

The actual controller 193 controls the formation unit 160 to form the valid part V1 of the first image P1 represented with the first image information that the decode unit 150 decoded and the valid part V2 of the second image P2 represented with the second image information onto the medium so that the valid part V1 and the valid part V2 are located at the correct positions respectively.

Then the actual controller 193 controls the folding unit 170 to fold the stacked media on which the formation unit 160 formed the images. Then the actual controller 193 controls the trimming unit 180 to trim the edge of the stack of the media that the folding unit 170 folded.

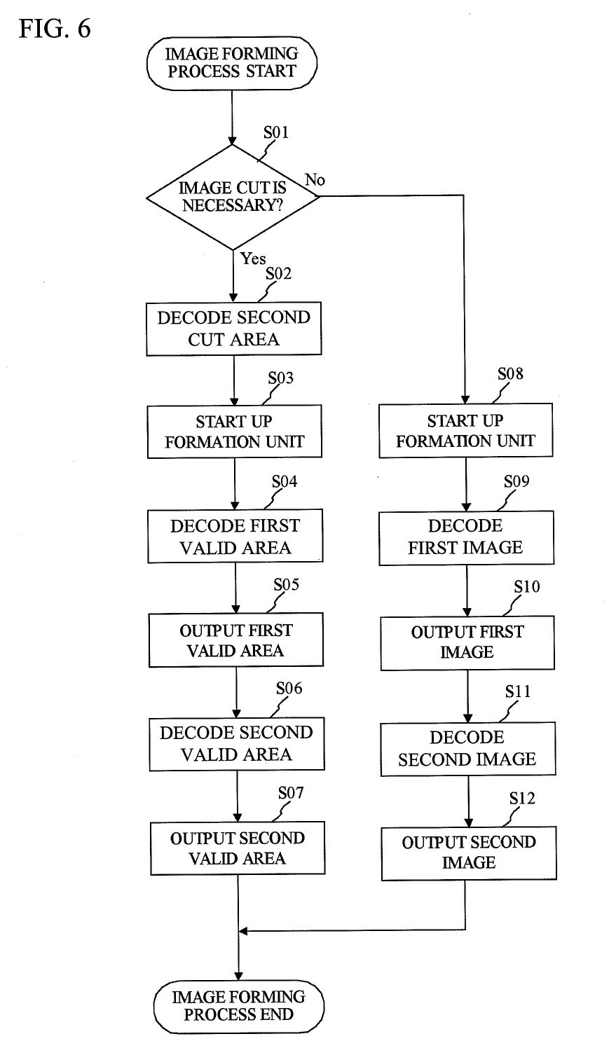

The image forming process that the image forming apparatus 100 executes to form the image will be described with reference to FIG. 6. FIG. 6 is a diagram illustrating an example of the image forming process that the image forming apparatus 100 executes.

The image forming apparatus 100 determines whether an image cut is necessary (step S01). When the image forming apparatus 100 determines that the image cut is necessary, it executes the procedure of the step S02, if not, it executes the procedure of the step S08.

In the step S01, when the image forming apparatus 100 determines that the image cut is necessary, it decodes the compressed information that represents the cut part (cut area) C2 of the second image P2 (step S02). Then the image forming apparatus 100 starts up the formation unit 160 (step S03). More specifically, the image forming apparatus 100 sets “high” to the pagesync.

Then, the image forming apparatus 100 decodes the compressed information that represents the valid part (valid area) V1 of the first image P1 (step S04). Then, the image forming apparatus 100 forms (outputs) the valid part V1 that the decoded information represents onto the medium (step S05). Then, the image forming apparatus 100 decodes the compressed information that represents the valid part V2 of the second image P2 with the information that is acquired in the step S02 and represents the cut part C2 (step S06). The image forming apparatus 100 forms the valid part V2 that the decoded information represents onto the medium (step S07). Then the image forming apparatus 100 ends the execution of the image forming process.

In the step S01, when the image forming apparatus 100 determines that the image cut is unnecessary, it starts up the formation unit 160 (step S08). Then, the image forming apparatus 100 decodes the compressed information that represents the first image P1 (step S09). The image forming apparatus 100 forms the first image P1 that the decoded information represents onto the medium (step S10). Then, the image forming apparatus 100 decodes the compressed information that represents the second image P2 (step S11). Then, the image forming apparatus 100 forms the second image P2 that the decoded information represents onto the medium (step S12). Then, the image forming apparatus 100 ends the execution of the image forming process.

In this embodiment, the image forming apparatus 100 includes the two memories 156a and 156b, and forms two images onto a single medium. However, the present invention is not limited to this embodiment. For example, the image forming apparatus 100 can include more than two memories and form more than two images onto a single medium.

In this embodiment, the first selection unit 151 corresponds to an example of a selection unit, memories 156a and 156b are examples of memories, the actual decode unit 153 corresponds to an example of a decode unit, the formation unit 160 corresponds to an example of a formation unit, the folding unit 170 corresponds to an example of a folding unit, the trimming unit 180 corresponds to an example of a trimming unit, the acquisition unit 191 corresponds to an example of an acquisition unit, the determination unit 192 corresponds to an example of a determination unit, and the actual controller 193 corresponds to an example of a controller.

A part of or all of functions that the image forming apparatuses 100 implements with the execution of the software process can be implemented in the hardware circuit. A part of or all of functions that the image forming apparatuses 100 implements with the hardware circuit can be implemented in the execution of the software process.

The program describing the process that the image forming apparatuses 100 executes can be supplied by providing a magnetic disk, an optical disk, a semiconductor memory, or other recording media to which the program is stored, or delivering the program via the network.

It should be noted that the present invention is not limited to those exemplary embodiments, and various modifications may be made to them without departing from the scope of the invention.

What is claimed is:

1. An image forming apparatus comprising:
an acquisition unit that acquires image information that represents an image;
a formation unit that forms the image that the image information that the acquisition unit acquires represents onto a medium;
a trimming unit that trims the medium onto which the formation unit forms the image; and
a determination unit that determines an edge cut from the image based on the size of a trimmed part of the medium trimmed by the trimming unit, the size of the medium, and the size of the image that the image information represents,
wherein the formation unit forms the image of which the edge that the determination unit determines to cut is cut onto the medium so that the edge of the image is located at a position based on the trimmed part that the trimmed unit trims.

2. The image forming apparatus according to claim 1, further comprising a folding unit that folds a medium onto which the formation unit forms the image, wherein the determination unit determines a cut part of the edge cut from the image based on the folding line along which the folding unit folds the medium.

3. The image forming apparatus according to claim 1, further comprising a decode unit that decodes information that represents a valid part of the image that the determination unit determines not to cut in the image information that the acquisition unit acquires;
more than two memories that store information that the decode unit uses for decoding image information; and
a selection unit that selects the image information that the decode unit decodes from more than two image information that the acquisition unit acquires,
wherein the image information that the acquisition unit acquires represents the image with compression, and the formation unit forms valid parts of the images represented with more than two image information that the decode unit decodes.

4. The image forming apparatus according to claim 2, further comprising a decode unit that decodes information that represents a valid part of the image that the determination unit determines not to cut in the image information that the acquisition unit acquires;
more than two memories that store information that the decode unit uses for decoding image information; and
a selection unit that selects the image information that the decode unit decodes from more than two image information that the acquisition unit acquires,
wherein the image information that the acquisition unit acquires represents the image with compression, and the formation unit forms valid parts of the images represented with more than two image information that the decode unit decodes.

5. The image forming apparatus according to claim 3, wherein the image information that the acquisition unit acquires compresses a line of pixels that composes the image with a description that refers to a line of pixels that information, which lies anterior to the line of pixels that composes the image, represents;
the memories store the information that represents the line of pixels represented with the information that lies anterior to the line of pixels that the image information that the decode unit decodes represents;
the selection unit selects the image information in order of that the formation unit forms the image, after selecting the image information that represents the image with the information that the cut part that the determination unit determines lies anterior to the valid part; and
the decode unit sequentially outputs the valid part that the decoded information of the image information that the selection unit selects represents to the formation unit with the information stored in the memories, after storing the decoded information of the information that represents the cut part which lies anterior to the valid part among the image information that the selection unit selects in the memories.

6. The image forming apparatus according to claim 4, wherein the image information that the acquisition unit acquires compresses a line of pixels that composes the image with a description that refers to a line of pixels that information, which lies anterior to the line of pixels that composes the image, represents;
the memories store the information that represents the line of pixels represented with the information that lies anterior to the line of pixels that the image information that the decode unit decodes represents;
the selection unit selects the image information in order of that the formation unit forms the image, after selecting the image information that represents the image with the information that the cut part that the determination unit determines lies anterior to the valid part; and
the decode unit sequentially outputs the valid part that the decoded information of the image information that the selection unit selects represents to the formation unit with the information stored in the memories, after storing the decoded information of the information that represents the cut part which lies anterior to the valid part among the image information that the selection unit selects in the memories.

7. An image forming method comprising:
acquiring image information that represents an image;
determining an edge cut from the image based on the size of a trimmed part trimmed from a medium onto which the image that the image information acquired represents is formed, the size of the medium, and the size of the image that the image information represents; and
controlling the formation unit that forms the image that the image information acquired represents to form the image onto the medium so that the edge of the image determined to be cut is located at the position based on the trimmed part.

8. A computer readable medium causing a computer to execute a process, the process comprising:
acquiring image information that represents an image;
determining an edge cut from the image based on the size of a trimmed part trimmed from a medium onto which the image that the image information acquired represents is formed, the size of the medium, and the size of the image that the image information represents; and
controlling the formation unit that forms the image that the image information acquired represents to form the image onto the medium so that the edge of the image determined to be cut is located at the position based on the trimmed part.
